(19) United States
(12) Patent Application Publication
(10) Pub. No.: US 2016/0191245 A1
(43) Pub. Date: Jun. 30, 2016

(54) Method for Offline Authenticating Time Encoded Passcode

(71) Applicant: Yufeng Qin, Saratoga, CA (US)

(72) Inventor: Yufeng Qin, Saratoga, CA (US)

(21) Appl. No.: 15/065,743

(22) Filed: Mar. 9, 2016

(51) Int. Cl. H04L 9/32; H04L 29/06

(52) U.S. Cl. CPC H04L 9/3226; H04L 63/06; H04L 63/0846

(57) ABSTRACT

A method is capable of offline authenticating a passcode which is generated online by encoding time related information with a shared private key. The authentication process decodes the time related information from passcode with the same shared private key and compares the decoded time related information with the point of time of authenticating to determine whether the passcode is valid at the present time or not. The authentication is performing locally and independently without connection to other separated device, services, components or storage.

### FIELD OF INVENTION

The present invention relates generally to a passcode generation and authentication. More specifically, this invention relates to encoding time related information with a shared private key into ASCII code as passcode and relates to authenticating the passcode. More specifically, this invention relates to authenticate locally passcode in offline mode without any sort of connection to other detached components or remote services. More specifically, this invention relates to asynchronous authentication process which takes place not at the same time as generation process.

### BACKGROUND OF THE INVENTION

The traditional passcode generation method is to generate a passcode by a software program or by user manually, then such passcode is stored into storage layer which is a physically existing medium , for example, memory or database or note book or chips in an electrical device. When authenticating a passcode, the traditional authentication method will ask the user to provide the passcode then compare the provided password with the existing passcode which is retrieved from storage media or service. If provided passcode and stored passcode matches, authentication successes, otherwise, authentication fails.

The traditional passcode authentication method compares user's input passcode with stored passcode, which is a passcode to passcode approach. The passcode won't change if not explicitly updating it.

There are a couple of drawbacks or limits for the traditional passcode generation and authentication mechanism:

Passcode has to be stored to a medium in order to authenticate user input passcode because authentication process need to obtain the passcode on demand then compare with user provided passcode.

The passcode authentication process is tightly coupled with the process of passcode generation process in the traditional method when authentication is taking place because the authentication process need to access the passcode storage location, to where the generation process stores the passcode, or to access service to retrieve passcode. Take a mobile application authentication as an example, when a passcode is generated on mobile device, it is stored locally in device or somewhere in a remote server. When authenticating on mobile device, the authentication process need access local storage or remote server to retrieve the passcode. The shared storage component makes the authentication process coupling with the passcode generation process, thus makes the authentication dependant on storage component.

Passcode cannot be changed by generating process independently. If a new passcode is produced in generating process, it must be synchronized between passcode generation and authentication process. That means passcode change require directly or indirectly connection between generation and authentication process.

Passcode is not time-aware when it generated. That means passcode will be always valid if the stored passcode, on which authentication process relies to verify the provided passcode, is not explicitly changed or disabled.

The present invention is to overcome the above limits of traditional passcode generation and authentication method by encoding the time related information into passcode to remove the dependence on storage of passcode and using a shared key to make generation and authentication totally independent.

### BRIEF SUMMARY OF THE INVENTION

The present invention changes the authentication process to obtain time related information by decoding user's input passcode, then compares the decoded time related information with the point of time, when the authentication is taking place, in a passcode to point of time approach.

The content of passcode is meaningful in present invention because the time information is already encoded into passcode itself, so there is no need for physical storage to store passcode so that the generation and authentication process can be totally separated. New passcode can be freely generated by generating process without the need to synchronize new passcode to authenticating process.

Because the time information is already encoded when a passcode is generated so the passcode is time-aware and it is only valid for a certain of time period as the encoded time related information specifies.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

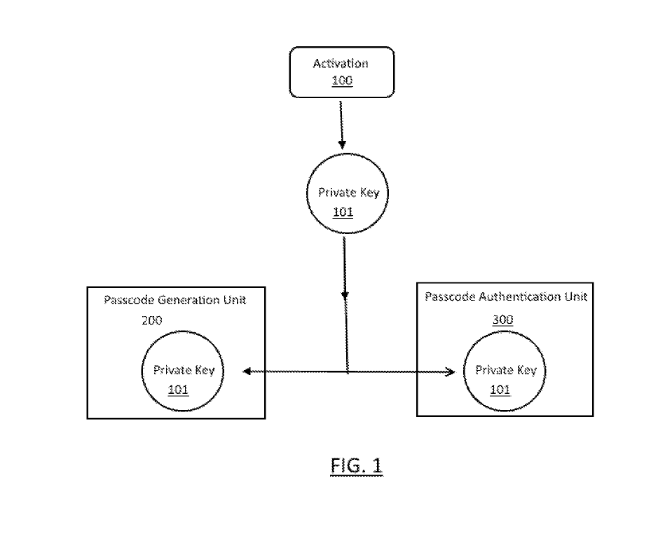

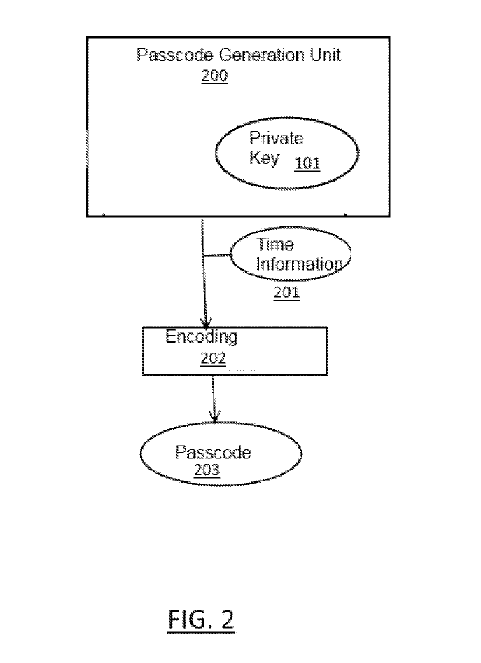

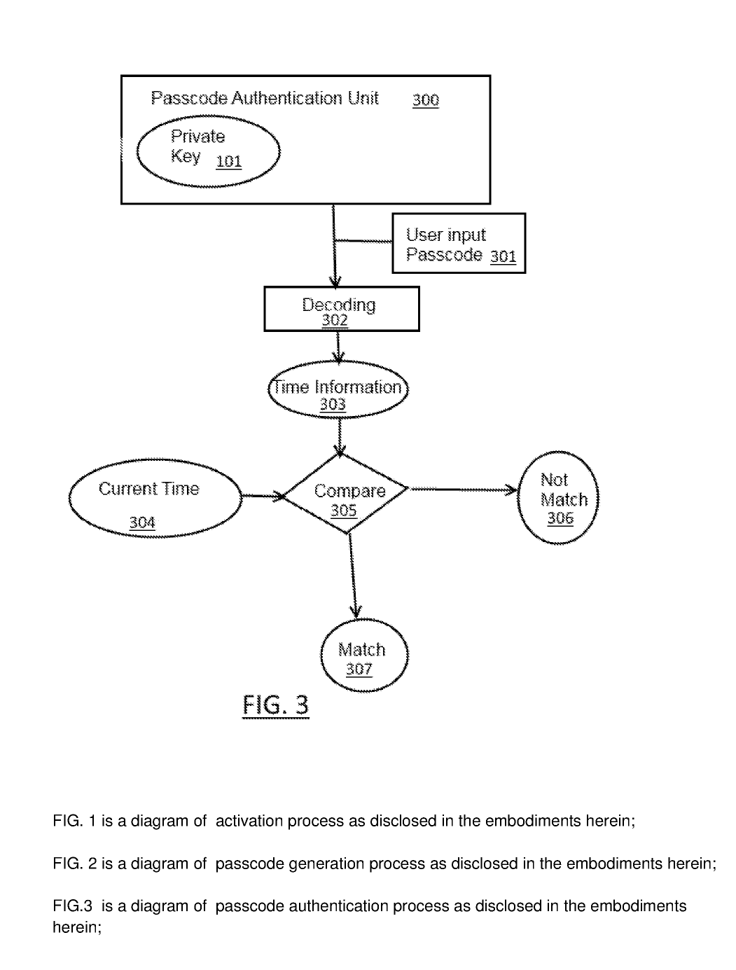

The embodiments herein disclose a method to encode time related information into a passcode and to authenticate a passcode against present point of time without connection to other device or service. Referring now to the drawings, and more particularly to FIG. 1, FIG. 2 and FIG. 3, where similar reference characters denote corresponding features consistently throughout the figures, there are shown embodiments.

FIG. 1 is a diagram of activation logic. Activation 100, which can be initiated manually by a user or automatically by a software application or service, generates automatically private key 101 or obtains private key 101 from other place, then activation process 100 send the private key 101 to Passcode Generation Unit 200 and/or Passcode Authentication Unit 300 so that both units hold the same private key 101. Private Key 101 is a serial of unique random ASCII code and it should be kept secretly and only known to each Passcode Generation Unit 200 and Passcode Authentication Unit 300 pair. Activation 100 is only required once to pair Passcode Generation Unit 200 and Passcode Authentication Unit 300.

FIG. 2 is a diagram of passcode generation logic as disclosed in the embodiments herein. Passcode Generation Unit 200 is to generate passcode. Examples of the Passcode Generation Unit 200 are but not restricted to web server, mobile device, standalone computer application and so on. When generating passcode, the time information 201,which specifies when and how long this passcode is valid and other criteria, must be provided. Examples of the such time information 201 are but not restricted to valid start time such as Jul. 4, 2016 18:30 PM, end time such as Jul. 4, 2016 22:30 PM, valid count to authentication such as 1, which means the passcode generated from this time information will be only validate from Jul. 4, 2016 18:30 PM to Jul. 4, 2016 22:30 PM, later or early than that time period, the passcode will be invalid. Passcode Generation Unit 200 will use Private Key 101,which obtained in activation process, and the provided time information 201 together to start Encoding 202. Encoding 202 process will use special algorithm to generate Passcode 203. The algorithm is predefined and well-known both to Passcode Generation Unit 200 and Passcode Authentication Unit 300. Passcode 203 appears like serial of random ASCII code and meaningless to human being.

FIG. 3 is a diagram of passcode authentication logic as disclosed in the embodiments herein. Passcode Authentication Unit 300 is to authenticate a user provided passcode.Examples of the Passcode Authentication Unit 300 are but not restricted to electric lock, garage opener, mobile device, web server, computer application and so on.When authenticating passcode, Passcode Authentication Unit 300 will ask User input Passcode 301, and then use Private Key 101 to start Decoding 302 process. Decoding 302 process will decode time related information 303, which is the exact same information as provided in time information 201, from Passcode 301. After obtaining the decoded time information 303, Passcode Authentication Unit 300 will query current time 304, then start Compare 305 process. Compare 305 process will compare decoded time information 303 and current time 304, if current time 304 falls in the time range of time information 303, then a Match 307 result is achieved, otherwise No Match 306 result is achieved. Take the time information example provided in above paragraph, if the time, when user input the passcode, is any time between Jul. 4, 2016 18:30 PM to Jul. 4, 2016 22:30 PM, then the passcode is valid, otherwise is invalid.

I claim:

1. A method of offline authenticating a passcode which is generated online, comprising:
generating a random ASCII code as a private key;
storing said private key in passcode generation unit and passcode authentication unit;
activating said private key so that the one to one relationship pair of said passcode generation unit and passcode authentication unit is stored and permanently referred each other;
providing user interface in said passcode generation unit to allow time related information to be input;
encoding said time related information with said private key to generate a time aware passcode; tracking real time inside said passcode authentication unit by using real-time clock;
providing user interface in said passcode authentication unit to take in user input passcode;
decoding said user input passcode with said private key in said passcode to a decoded time related information in authentication unit;and
authenticating the said decoded time related information by comparing it with the present point of time to determine the validation of said passcode so that authentication successes can be achieved if and only if said decoded time related information conforms to said present point of time.

2. The method of claim 1 wherein further comprises:
a public published label of said passcode authentication unit; and
said label and said private key is stored altogether as a relation mapping pair in a place said passcode generation unit can access so that said passcode generation can locate the said private key of said passcode authentication unit by looking up the said label of passcode authentication unit.

3. The method of claim 1 wherein the generated time related information comprises a representation of starting date and time.

4. The method of claim 1 wherein the generated time related information comprises a representation of ending date and time.

5. The method of claim 1 wherein the generated time related information comprises a representation of amount of time to be valid when authenticating.

6. The method of claim 1 wherein the generated time related information comprises a representation of how many times this passcode can be authenticated when authenticating, one time only, given times or infinite times.

7. The method of claim 1 wherein the generated time related information comprises a representation of periodicity of time period of validation.

8. The method of claim 1 wherein the user interface to take user input comprises web application to allow user input time information in passcode generation unit.

9. The method of claim 1 wherein the user interface to take user input comprises mobile app to allow user input time information in passcode generation unit.

10. The method of claim 1 wherein encoding time related information comprises looking up said private key for said passcode authentication unit in passcode generation unit then encode said time information with said private code to generate the time realted passcode.

11. The method of claim 1 wherein encoding time information with private key comprises algorithms to randomize the said generated passcode so that there is no identifiable pattern between the time related information and the said generated passcode.

12. The method of claim 1 wherein user interface in said passcode authentication unit comprises an keypad to allow user to input passcode.

13. The method of claim 1 wherein tracking real time comprises a mechanism to adjust time if there is time drift in real time clock.

14. The method of claim 1 wherein authenticating user's input is performing locally without relying on any component which is not physically connected to or not integrated part of said passcode authentication unit.

15. The method of claim 1 wherein authenticating user's input is performing independently without relying on any form of connections to other services which is not physically connected to or not integrated part of said passcode authentication unit.

16. The method of claim 1 wherein authenticating user's input is performing asynchronously at any time after said passcode is generated from said passcode generation unit.

17. The method of claim 1 wherein authenticating user's input comprises a mechanism to disable said passcode authentication unit if a certain amount of failed attempts exceeds.

18. The method of claim 1 wherein authenticating user's input comprises a mechanism to ignore user input for a certain time in said passcode authentication unit if a certain amount of failed attempts exceeds.

19. The method of claim 1 wherein authenticating user's input comprises a mechanism to prolong the time interval to accept next user input in said passcode authentication unit if a certain amount of failed attempts exceeds.
